(19) United States
(12) Patent Application Publication
(10) Pub. No.: US 2015/0026505 A1
(43) Pub. Date: Jan. 22, 2015

(54) STORAGE DEVICE, STORAGE SYSTEM, AND BACKGROUND PROCESSING EXECUTION METHOD

(71) Applicant: KABUSHIKI KAISHA TOSHIBA, TOKYO (JP)

(72) Inventor: Michio Yamamoto, Inagi-shi (JP)

(73) Assignee: KABUSHIKI KAISHA TOSHIBA, TOKYO (JP)

(21) Appl. No.: 14/088,771

(22) Filed: Nov. 25, 2013

Related U.S. Application Data
(60) Provisional application No. 61/847,435, filed on Jul. 17, 2013.

(51) Int. Cl. G06F 1/12; G06F 1/08

(52) U.S. Cl. CPC G06F 1/12; G06F 1/08
USPC 713/400; 713/600

(57) ABSTRACT

According to an embodiment, a storage device includes a storage medium and a controller. The controller manages a local clock, adjusts the local clock in accordance with an order for adjustment of the managed local clock, and executes background processing involving access to the storage medium on the basis of the adjusted local clock.

### CROSS-REFERENCE TO RELATED APPLICATIONS

This application is based upon and claims the benefit of priority from U.S. Provisional Application No. 61/847435, filed on Jul. 17, 2013; the entire contents of which are incorporated herein by reference.

### FIELD

Embodiments described herein relate generally to a storage device, a storage system, and a background processing execution method.

### BACKGROUND

A technique of providing a plurality of storage devices (for example, hard disk drives) and distributing and storing data in the storage devices is known. This technique is called RAID (Redundant Array of Inexpensive Disks), and reliability improvement is implemented by writing data received from a host device into two or more storage devices and managing the data. A system to which this technique is applied includes a plurality of storage devices and a control device (controller) which executes data relay and the like between the respective storage devices and the host device. Upon receiving an order from the control device, each storage device executes processing indicated by contents of the order, for example, data write processing or read processing.

In processing executed by the storage device, processing executed autonomously at predetermined timing (hereafter this processing is referred to as background processing) exists besides processing executed when ordered by another device. For example, in case of a hard disk drive (hereafter referred to as HDD), there are processing executed to store disk statistics information, LBA (Logical Block Addressing) address management information, cache data, and the like onto a disk, and processing executed to check and rewrite user data for the quality keeping of a user data area (BMS (Background Media Scan), an ATI (Adjacent Track Interference) countermeasure, and write off track retry), as background processing involving disk access. In a case where the HDD executes these kinds of background processing, the start timing was determined by the HDD alone in the conventional system.

If a request involving access to data, such as data reading or data writing, is received from the host device in a configuration in which data is distributed to and recorded in a plurality of storage devices, such as the RAID, therefore, data access processing is delayed by a cause of the background processing and data access performance of the whole system was degraded. In other words, if a request involving access to data is received while a storage device is executing background processing involving access to a storage medium, it is necessary to execute data access processing depending upon the request after finishing the background processing and a delay is caused until data access processing is started. In the conventional system in which a plurality of storage devices execute background processing at unique timing, the possibility that some storage device will be executing background processing at a time when a request of data access processing is received is high. As a result, there is a problem that delays are caused frequently and the data access performance of the whole system is degraded.

Furthermore, there is a case where the plurality of storage devices execute background processing in a concentrative manner during a certain period. Or conversely, there is a case where any storage devices do not execute background processing. There is also a problem that variation occurs in the command processing performance of the system and the command processing function of the system becomes unstable.

### BRIEF DESCRIPTION OF THE DRAWINGS

FIG. 1 is a diagram illustrating a configuration example of a storage system to which a storage device according to a first embodiment is applied.

FIG. 2 is a diagram illustrating a configuration example of the storage device.

FIG. 3 is a diagram illustrating a use example of RAM;

FIG. 4 is a flow chart illustrating an operation example of a background processing control module.

FIG. 5 is a sequence diagram illustrating an operation example of the storage system.

FIG. 6 is a diagram illustrating relations between local clocks in two storage devices.

FIG. 7 is a diagram illustrating an execution timing example of background processing in two storage devices.

FIG. 8 is a diagram illustrating an execution timing example of background processing in two storage devices.

FIG. 9 is a sequence diagram illustrating an operation example of a storage system according to a second embodiment.

FIG. 10 is a sequence diagram illustrating an operation example of a storage system according to a third embodiment.

### DETAILED DESCRIPTION

According to an embodiment, a storage device includes a storage medium and a controller. The controller manages a local clock, adjusts the local clock in accordance with an order for adjustment of the managed local clock, and executes background processing involving access to the storage medium on the basis of the adjusted local clock.

Hereafter, a storage device, a storage system, and a background processing execution method according to each of embodiments will be described in detail with reference to accompanying drawings. However, the present invention is not limited to the embodiments.

### First Embodiment

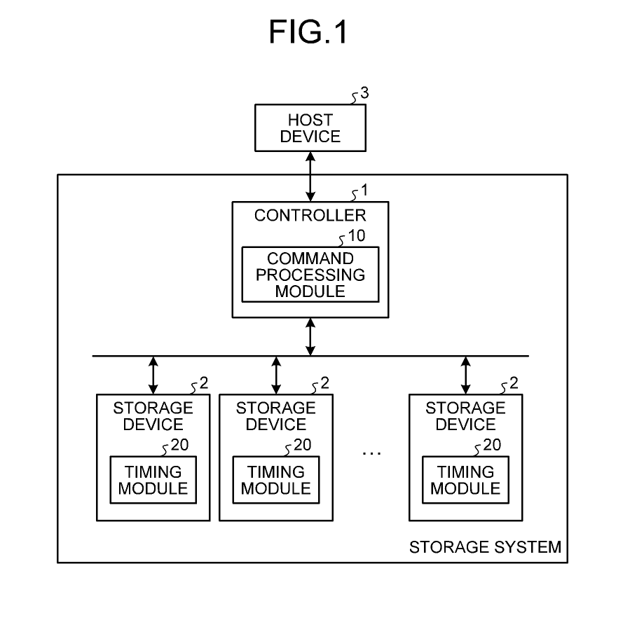

FIG. 1 is a diagram illustrating a configuration example of a storage system to which a storage device according to a first embodiment is applied. The storage system in the present embodiment includes a controller 1, which is a control device, and a plurality of storage devices 2. A host device 3 is connected to the controller 1. Furthermore, the controller 1 includes a command processing module 10 which issues a command to the storage devices 2. The plurality of storage devices 2 have the same configuration, and each storage device 2 includes a timing module 20 which manages internal time (local clock).

In the storage system illustrated in FIG. 1, data received from the host device 3 is distributed and recorded into a plurality of storage devices 2. Here, “distributed and recorded” includes both a mode in which same data is recorded into a plurality of storage devices 2 in order to improve the reliability and a mode in which one data is divided and recorded into a plurality of storage devices 2 with the object of improving the processing speed (such as data writing speed and reading speed). Furthermore, although details will be described later, the command processing module 10 in the controller 1 issues a command to each storage device 2 to order time adjustment. As a result, it becomes possible in this storage system to adjust the local clock managed in the timing module 20 in each storage device 2, from the controller 1 side.

By the way, in the present embodiment, a case where the storage device 2 is a hard disk drive will be described. However, the storage device may be, for example, an SSD (Solid State Drive).

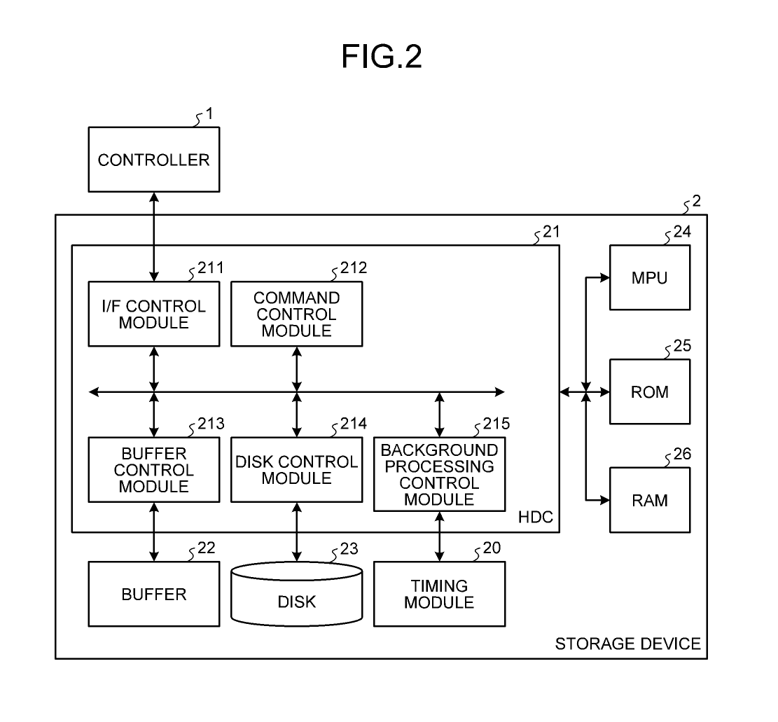

FIG. 2 is a diagram illustrating a configuration example of each storage device 2. As illustrated, the storage device 2 includes the timing module 20 configured to manage a local clock, a hard disk controller (HDC) 21 configured to include an I/F (interface) control module 211, a command control module 212, a buffer control module 213, a disk control module 214, and a background processing control module 215 and control modules in the storage device 2, a buffer 22 configured to temporarily retain data and the like delivered with an external device, a disk 23 configured to record data, an MPU (Micro Processing Unit) 24, ROM (Read Only Memory) 25, and RAM (Random Access Memory) 26.

In the HDC 21, the I/F control module 211 executes delivery of various commands and data with the controller 1. The command control module 212 transmits/receives various commands to/from the command processing module 10 in the controller 1, and executes processing according to a command received from the controller 1. For example, if a command (data write command) ordering data writing is received, the command control module 212 writes data received together with the data write command onto the disk 23 via the disk control module 214. If background processing involving access to the disk 23 is being executed at a time when a command ordering processing involving access to the disk 23, however, the command control module 212 executes the processing ordered by the command after waiting for end of the background processing. The buffer control module 213 executes data writing, reading and erasing with respect to the buffer 22. The disk control module 214 executes data writing, reading and erasing with respect to the disk 23 in accordance with an order from the command control module 212 or the background processing control module 215. The background processing control module 215 controls background processing on the basis of the local clock managed by the timing module 20. Furthermore, if the background processing control module 215 is ordered to adjust the local clock by the controller 1, the background processing control module 215 adjusts the local clock managed by the timing module 20.

The MPU 24 controls the control modules in the HDC 21 by developing a program stored in the ROM 25 into the RAM 26 and executing the program. The ROM 25 retains programs and various kinds of information for operating the storage device 2. The RAM 26 is used as a developing memory and a working memory of the programs and information stored in the ROM 25.

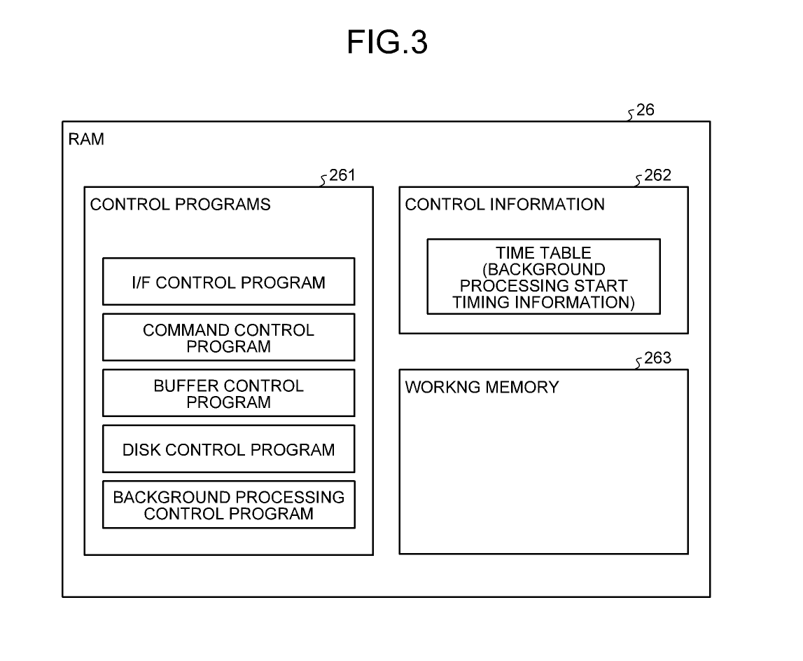

FIG. 3 is a diagram illustrating a use example of the RAM 26. In a state in which a power supply of the storage device 2 is turned on, control programs 261 and control information 262 are developed into the RAM 26 as illustrated. Furthermore, a partial area is used as a working memory 263.

The control programs 261 include an I/F control program configured to implement the I/F control module 211, a command control program configured to implement the command control module 212, a buffer control program configured to implement the buffer control module 213, a disk control program configured to implement the disk control module 214, and a background processing control program configured to implement the background processing control module 215. The control information 262 includes a time table in which background processing start timing information described later is registered.

Upon determining that the local clocks in the storage devices 2 are in a state in which synchronization is not attained, in the storage system configured to include a plurality of storage devices 2 each having the above-described configuration, the controller 1 issues a command to order each storage device 2 to adjust the local clock and causes the local clocks of the storage devices 2 to synchronize with each other. Each storage device 2 executes background processing in accordance with the local clock and preset schedule. Upon receiving a command from the controller 1, the storage device 2 executes processing indicated by the command. For example, upon receiving a data write command, the storage device 2 stores data received from the controller 1 into a specified area on the disk 23. Upon receiving an order (command) to adjust the local clock, the storage device 2 adjusts the local clock managed by the timing module 20. In a case where the storage device receives a command while background processing is being executed, the storage device 2 executes processing corresponding to the command after the background processing is finished, depending upon a kind of the background processing under execution. Specifically, in a case where the storage device 2 receives a command ordering processing (such as data reading or data writing) involving access to the disk 23 in a state in which the storage device 2 is executing background processing involving access to the disk 23, the storage device 2 executes processing corresponding to the received command after finishing the background processing under execution.

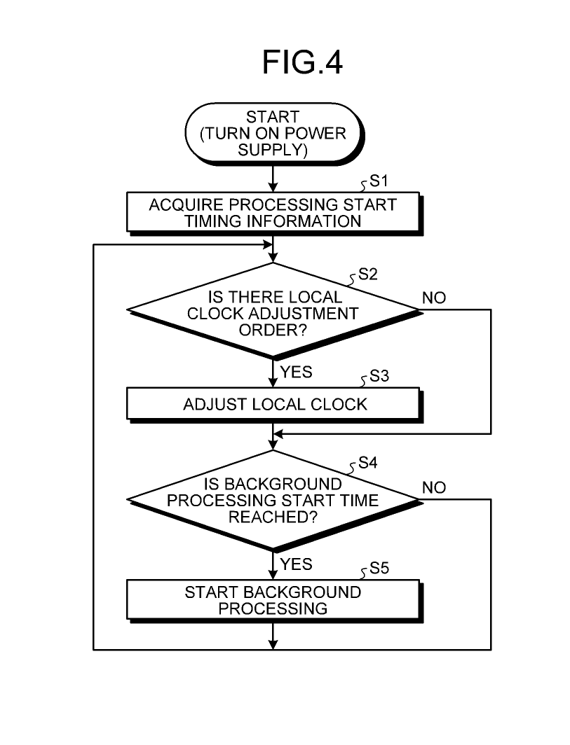

Operation of the background processing control module 215 in the storage device 2 will now be described with reference to FIG. 4. FIG. 4 is a flow chart illustrating an operation example of the background processing control module 215.

If the power supply is turned on, the background processing control module 215 first refers to a time table included in the control information 262, and acquires background processing start timing information (step S1). Here, the background processing start timing information is information which indicates execution times respectively of a plurality of kinds of background processing. For example, identification information of background processing to be executed and execution time are registered in an associated state in the time table. An execution repetition period may be registered instead of the execution time. If time indicated by the background processing start timing information is reached, the background processing control module 215 executes the corresponding background processing. The background processing is, for example, processing of storing disk statistics information, LBA address management information, cache data and the like on a disk, processing of checking or rewriting user data in order to maintain the quality of the user data area, and the like.

Upon acquiring the background processing start timing information, the background processing control module 215 then determines whether a clock adjustment ordering command is received (step S2). If the adjustment ordering command is received (step S2: Yes), the background processing control module 215 adjusts the local clock in accordance with contents of the order (step S3). In other words, the background processing control module 215 orders the timing module 20 to adjust the local clock. Unless the adjustment ordering command is received (step S2: No), the background processing control module 215 determines whether the background processing start time is reached on the basis of the background processing start timing information and the local clock (step S4). If the background processing start time is reached (step S4: Yes), the background processing control module 215 starts corresponding background processing (step S5). At this time, it is made possible for the command control module 212 to know that processing is being executed by, for example, setting a flag to indicate that background processing is being executed. By the way, in a case where background processing cannot be started for the reason, for example, that different processing involving access to the disk 23 is being executed, for example, the background processing is started after the processing under execution completes or start of the background processing is suspended (the background processing is not executed), according to the degree of importance of the background processing. On the other hand, in a case where the background processing start time is not reached (step S4: No), the background processing control module 215 returns to the step S2 and determines whether the clock adjustment ordering command is received.

As described heretofore, the background processing control module 215 monitors reception of the clock adjustment ordering command and arrival of the background processing start timing. And in a case where the clock adjustment ordering command is received, the background processing control module 215 adjusts the local clock. In a case where the background processing start timing is detected, the background processing control module 215 executes background processing.

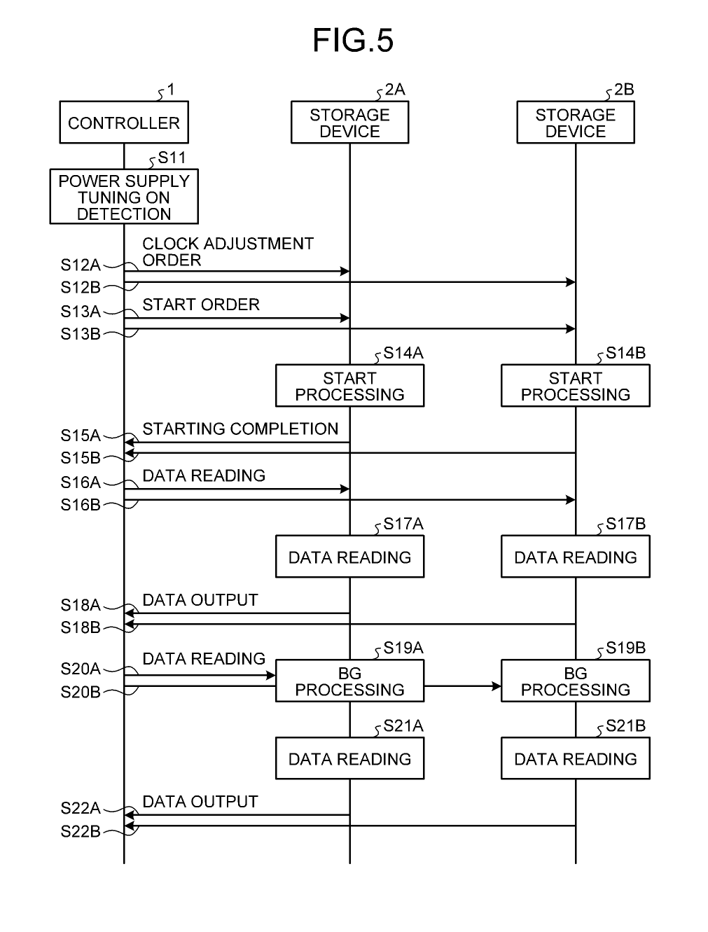

Operation of the storage system according to the present embodiment will now be described with reference to FIG. 5. FIG. 5 is a sequence diagram illustrating an operation example of the storage system. As an example, a case where the number of storage devices included in the storage system is two will now be described. Supposing that the two storage devices 2 are a storage device 2A and a storage device 2B, the operation will be described. It is supposed that the storage devices 2A and 2B retain background processing start timing information having the same contents.

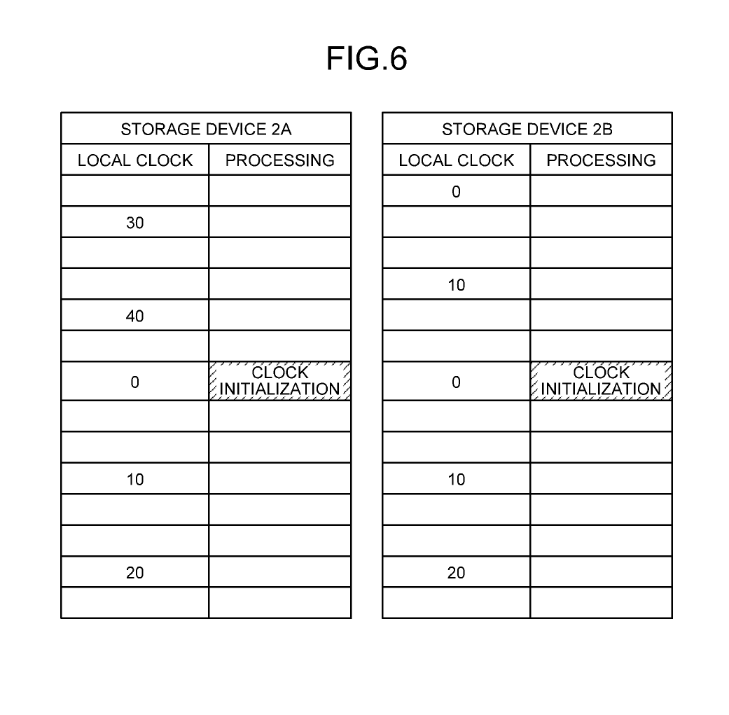

Upon detecting that the power supply of the storage system is turned on (step S11) in the operation according to the sequence illustrated in FIG. 5, the controller 1 orders the storage devices 2A and 2B to execute clock adjustment (steps S12A and S12B). In the clock adjustment order, for example, the storage devices 2A and 2B are notified of the time managed by the controller 1 and the storage devices 2A and 2B are ordered to set the local clocks to the notified time. This order is executed by the clock adjustment ordering command issued to the storage devices 2A and 2B by the command processing module 10. The command processing module 10 may order the storage devices 2A and 2B to initialize the local clocks. The storage devices 2A and 2B adjust the local clocks in accordance with contents of the order. As a result, the local clocks in the storage device 2A and the storage device 2B synchronize with each other (see FIG. 6). FIG. 6 illustrates an example of a case where synchronization is implemented by initializing local clocks.

In a case where the controller 1 and the storage devices 2A and 2B are SCSI (Small Computer System Interface)-connected, the controller 1 can give a clock adjustment order to the storage devices 2A and 2B by utilizing SET TIMESTAMP command defined as an SCSI command. Furthermore, in a case where the controller 1 and the storage devices 2A and 2B are SAS (Serial Attached SCSI)-connected, the controller 1 can give a clock adjustment order to the storage devices 2A and 2B by utilizing BROADCAST primitive defined as an SCSI command. It is also possible to newly define a command or a primitive for clock adjustment ordering and use it.

Referring back to FIG. 5, the controller 1 then gives a start order to the storage devices 2A and 2B (steps S13A and S13B). Upon receiving the start order, the storage devices 2A and 2B execute predetermined start processing for starting ordinary operation (steps S14A and S14B). Upon completing the processing, the storage devices 2A and 2B notify the controller 1 to that effect (steps S15A and S15B). In the start processing, for example, an operation check of the disk 23 is executed. If there are no problems, the controller 1 is notified of start completion.

By the way, the clock adjustment order (the steps S12A and S12B) and the start operation (the steps S13A to S15A and the steps S13B to S15B) may be reversed in execution order.

Upon detecting the start completion of the storage devices 2A and 2B, the controller 1 then executes data reading or data writing in accordance with a request from the host device 3 (steps S16A to S18A and steps S16B to S18B, steps S20A to S22A and steps S20B to S22B). Although an example of data reading is illustrated in FIG. 5, a case of data writing is also executed in the same way.

In the operation example illustrated in FIG. 5, the storage devices 2A and 2B receive data read requests at the steps S20A and S20B in a state in which the storage devices 2A and 2B are executing background processing (BG processing) (steps S19A and S19B). In this case, the storage devices 2A and 2B execute data read processing after completing or suspending the background processing under execution. In a case where the background processing is suspended and data read processing is executed, the storage devices 2A and 2B may resume the background processing after completing the data read processing, or may execute the background processing again at next background processing start timing (time indicated by the background processing start timing information).

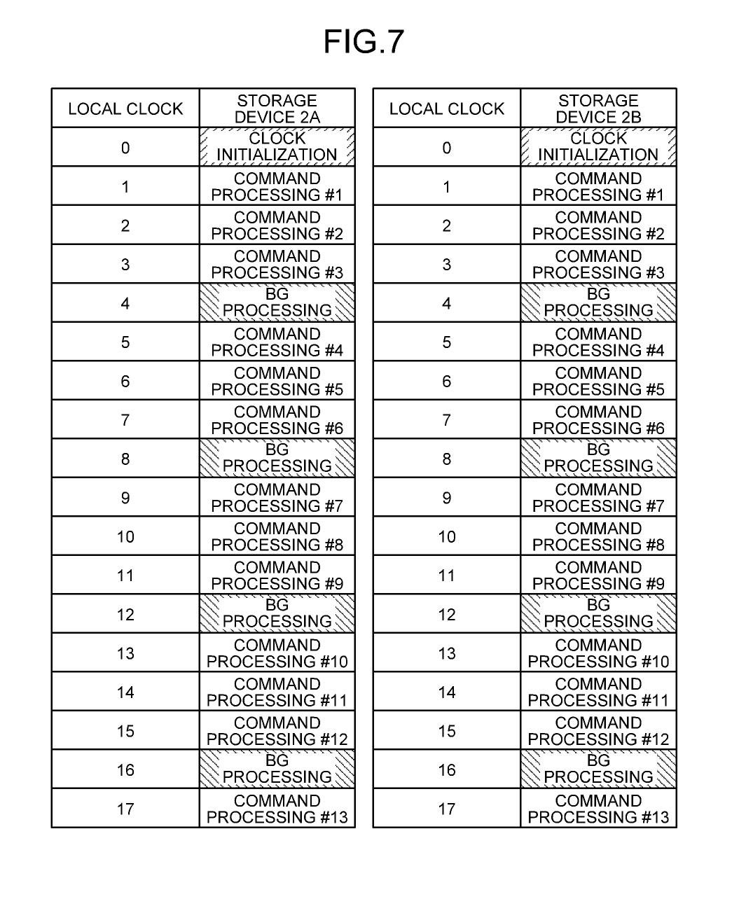

In a case where the local clocks synchronize with each other, the storage devices 2A and 2B retaining background processing start timing information having the same contents execute background processing (illustrated as BG processing in FIG. 7) and command processing at the same timing as illustrated in FIG. 7. The command processing is processing corresponding to the command received from the host device 3 via the controller 1. For simplifying the description, it is supposed that one piece of processing is executed at one clock in FIG. 7. In the example illustrated in FIG. 7, background processing is executed at a frequency of once every four clocks. Since time when the storage device 2A executes background processing coincides with time when the storage device 2B executes background processing, a delay caused in the system by illustrated background processing (four times in total) corresponds to only four clocks.

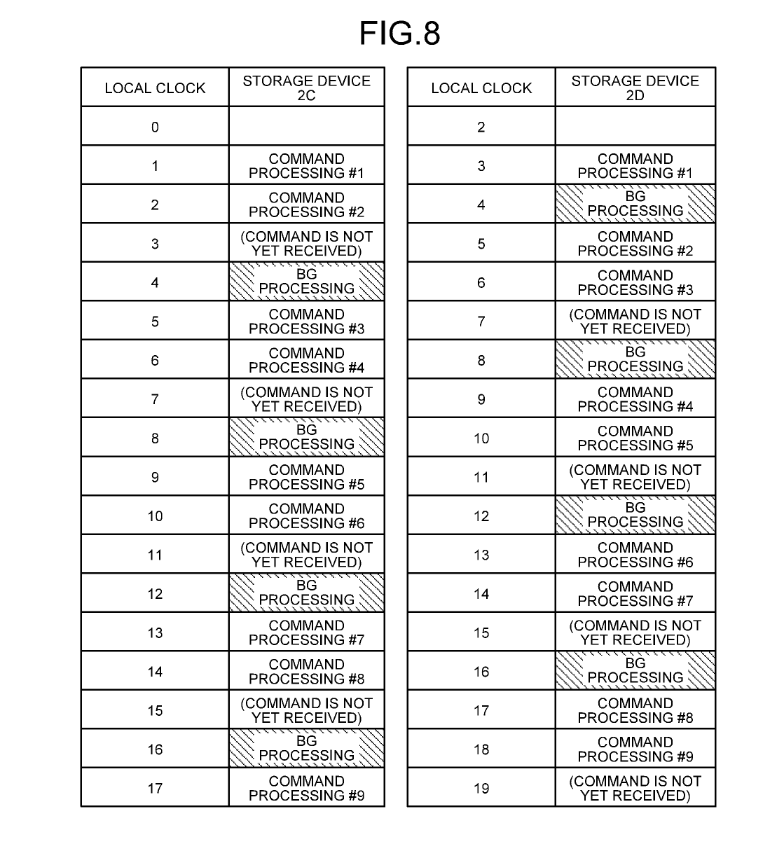

On the other hand, in a case where the local clocks do not synchronize with each other, two storage devices (represented as storage devices 2C and 2D) execute background processing at different timing as illustrated in FIG. 8. Therefore, each storage device (each of the storage devices 2C and 2D) is brought into a situation in which start of command processing for the other storage device is delayed due to a delay of command processing caused by background processing. In an example illustrated in FIG. 8, an execution order of command processing #2 is received at a time when the local clock in the storage device 2C is 2 and the local clock in the storage device 2D is 4. The storage device 2D is at execution timing of background processing. Accordingly, the command processing #2 in the storage device 2D is executed after the background processing is finished, i.e., at a time when the local clock is 5. In the other storage device 2C, the command processing #2 is executed at a time when the local clock is 2. Since the host device 3 waits for completion of the command processing #2 in the storage device 2D, however, the storage device 2C cannot receive the next command at a time when the local clock is 3, and a waiting time occurs. In the same way, if an execution order of command processing #3 is received at a time when the local clock in the storage device 2C is 4 and the local clock in the storage device 2D is 6, the storage device 2C is at execution timing of background processing and consequently the storage device 2D cannot receive the next command at a time when the local clock is 7, resulting in a waiting time.

In a case where the local clocks in the storage devices do not synchronize with each other in this way, the number of command processing which can be executed in 18 clocks becomes nine commands (see FIG. 8). On the other hand, in a case where the local clocks in the storage devices synchronize with each other, the number of command processing which can be executed in 18 clocks becomes thirteen commands (see FIG. 7). In other words, delay in caused in command processing by background processing which is executed autonomously by respective storage devices is reduced and the system performance is improved by causing the local clocks in a plurality of storage devices 2 included in the storage system to synchronize with each other.

In the storage system in the present embodiment, the storage devices 2 retain the background processing start timing information having the same contents as described heretofore. Upon receiving the local clock adjustment order, the storage devices 2 adjust the local clocks. As a result, it becomes possible for each of the storage devices 2 to execute background processing at the same timing as other storage devices 2, and processing delays caused by background processing in the storage devices 2 can be reduced.

By the way, the background processing for which the storage devices 2 align start timing may be restricted to background processing that remarkably delay start timing of processing requested by a command (processing requested by the controller 1). For example, (1) BMS (Background Media Scan), (2) ATI (Adjacent Track Interference) countermeasure processing, (3) log save (internal log information update), and (4) media cache update may be specified as background processing to be synchronized, and the storage devices 2 may retain start timing of these kinds of background processing as the background processing start timing information.

In the foregoing description, control for synchronizing the local clocks in the storage devices 2 (the steps S12A and S12B in FIG. 5) is executed by taking the turning on of the power supply as a trigger. However, it is also possible to execute first synchronization control after the turning on of the power supply and thereafter execute the synchronization control repetitively whenever a definite time period elapses.

### Second Embodiment

In the first embodiment, the controller 1 orders the storage devices 2 in the system to execute clock adjustment, and thereby causes local clocks in the storage devices 2 to synchronize with each other (see FIG. 5). On the other hand, in the present second embodiment, another method for synchronizing the local clocks will be described. By the way, configurations of the storage system and the storage devices are the same as those in the first embodiment.

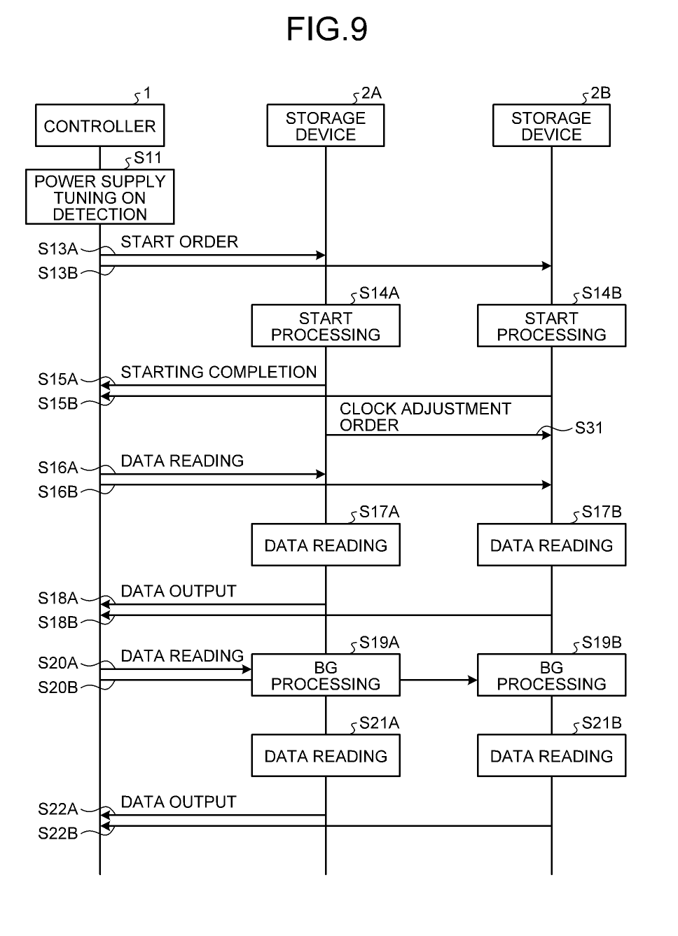

For example, in case of a system configuration in which the storage devices 2 can communicate with each other, control illustrated in FIG. 9 may be exercised. By the way, in FIG. 9, processing provided with the same step number as that in FIG. 5 is same processing as that in FIG. 5. In other words, in operation illustrated in FIG. 9, the storage device 2A included in the storage devices 2A and 2B orders the storage device 2B to execute clock adjustment and thereby causes the local clocks in the storage device 2A and the storage device 2B to synchronize with each other. That the storage device 2A gives an order to the storage device 2B is an example. The storage device 2B may give an order to the storage device 2A.

In the operation illustrated in FIG. 9, step S31 is executed instead of the steps S12A and S12B illustrated in FIG. 5. At the step S31, the storage device 2A orders the storage device 2B to execute clock adjustment after start processing is completed. Operations other than this are the same as those in FIG. 5. Order of the clock adjustment is given by, for example, the background processing control module 215. In case of a system having three or more storage devices, one storage device 2 orders other storage devices 2 to execute clock adjustment. The storage device 2 among a plurality of storage devices 2 that orders clock adjustment is predetermined.

In other words, in the storage system according to the present second embodiment, operation is the same as that in the first embodiment except that one storage device 2 orders other storage devices 2 to execute clock adjustment. In a case where the local clocks are adjusted according to a procedure in the present embodiment, effects similar to those in the first embodiment can also be obtained.

In the foregoing description, the processing (the step S31 in FIG. 9) of synchronizing the local clocks in the storage devices 2 is executed by taking turning on of the power supply as a trigger. However, it is also possible to execute first synchronization processing after the turning on of the power supply and thereafter execute the synchronization processing repetitively whenever a definite time period elapses.

### Third Embodiment

In the first and second embodiments, the local clocks are adjusted when the power supply of the storage system is turned on and the storage devices 2 are started. On the other hand, in the present embodiment, a case where the local clocks are adjusted at arbitrary timing after starting will be described. Configurations of the storage system and the storage devices are the same as those in the first embodiment.

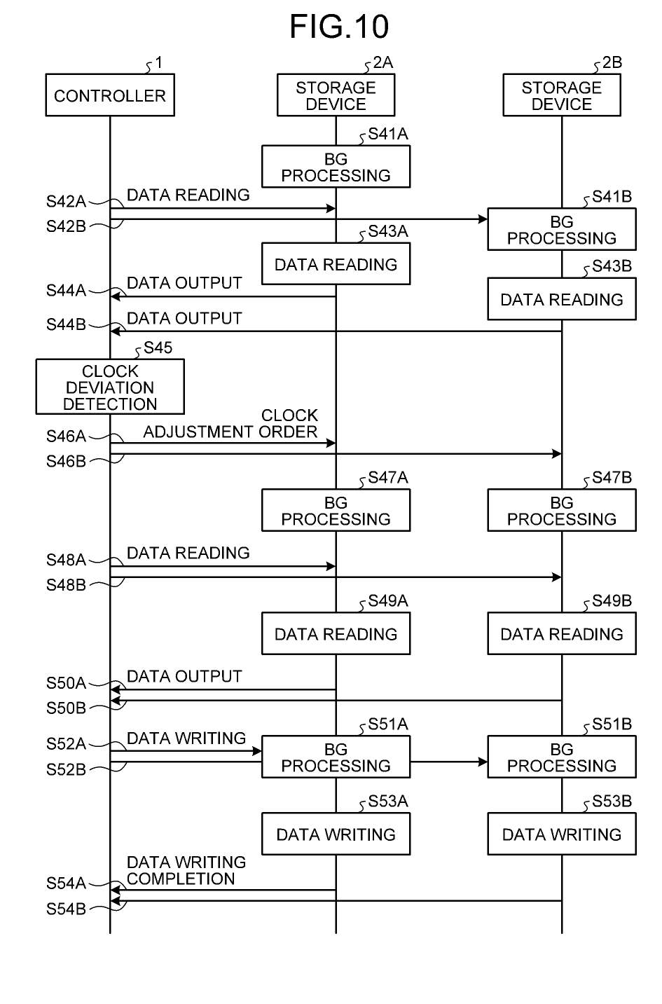

FIG. 10 is a sequence diagram illustrating an operation example of a storage system according to the third embodiment. By the way, a case where the storage system includes two storage devices 2A and 2B will be described in the same way as the first and second embodiments. Upon detecting a deviation between the local clock in the storage device 2A and the local clock in the storage device 2B, the controller 1 orders clock adjustment as illustrated in the sequence in FIG. 10.

In a state in which there is a deviation between the local clocks, background processing in the storage device 2A and background processing in the storage device 2B are executed at different timing (steps S41A and S41B). At a time when, in such a state, the controller 1 gives an order of processing (for example, data reading) that needs disk access, one of the storage devices 2 is executing background processing. As a result, there is a possibility that processing of the whole system will delay. In other words, if the controller 1 orders the storage devices 2A and 2B to read data in a state in which the storage device 2A is not executing background processing and the storage device 2B is executing background processing as in the example illustrated in FIG. 10, time required until data is output from the storage device 2B becomes long (steps S42A to S44A and steps S42B to S44B). In other words, a deviation occurs between data output timing from the storage device 2A and data output timing from the storage device 2B.

If a difference between the data output timing from the storage device 2A and the data output timing from the storage device 2B is at least a predetermined value, the controller 1 determines that there is a deviation between the local clock in the storage device 2A and the local clock in the storage device 2B (step S45), and orders the storage devices 2A and 2B to execute clock adjustment (steps S46A and S46B). In the clock adjustment order, for example, the storage devices 2A and 2B are notified of the time managed by the controller 1 and the storage devices 2A and 2B are ordered to set the local clocks to the notified time, in the same way as the steps S12A and S12B illustrated in FIG. 5. Or the controller 1 orders the storage devices 2A and 2B to initialize the local clocks. As a result, the local clocks in the storage device 2A and the storage device 2B synchronize each other. Thereafter, the storage devices 2A and 2B execute background processing at the same timing (steps S47A and S47B, and steps S51A and S51B). If the controller 1 orders the storage devices 2A and 2B to execute data reading, therefore, data are output from the storage devices 2A and 2B at the same timing (steps S48A to S50A and steps S48B to S50B). Furthermore, if the controller 1 orders the storage devices 2A and 2B to execute data writing, the writing is completed at the same timing (steps S52A to S54A and steps S52B to S54B).

Upon detecting occurrence of a deviation between the local clocks in the storage devices 2 in the storage system in the present embodiment, the controller 1 orders the storage devices 2 to execute local clock adjustment in this way. In a case where a deviation occurs in the local clocks in the storage devices 2 because of, for example, elapse of a long time after the local clocks are adjusted once, therefore, resynchronization can also be attained.

The present embodiment can be combined with the first embodiment or the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. In a storage system comprising a plurality of storage devices, and a control device configured to issue a command concerning data access to the plurality of storage devices, the storage device comprising:
a storage medium; and
a controller,
wherein the controller
manages a local clock,
adjusts the managed local clock in accordance with an order for adjustment of the managed local clock, and
executes background processing involving access to the storage medium on the basis of the adjusted local clock.

2. The storage device according to claim 1, further comprising a memory configured to retain information concerning start timing of the background processing involving access to the storage medium,
wherein the controller executes the background processing on the basis of the information retained in the memory and the local clock.

3. The storage device according to claim 2, wherein the memory retains same information as that retained in memories in other storage devices.

4. The storage device according to claim 1, wherein the controller adjusts the local clock in accordance with an order from the control device.

5. The storage device according to claim 2, wherein the controller adjusts the local clock in accordance with an order from the control device.

6. The storage device according to claim 1, wherein the controller adjusts the local clock in accordance with an order from another control device.

7. The storage device according to claim 2, wherein the controller adjusts the local clock in accordance with an order from another control device.

8. The storage device according to claim 1, wherein the controller further orders other storage devices to adjust local clocks to cause the managed local clock and local clocks managed in other storage devices to synchronize with each other.

9. The storage device according to claim 2, wherein the controller further orders other storage devices to adjust local clocks to cause the managed local clock and local clocks managed in other storage devices to synchronize with each other.

10. A storage system comprising a plurality of storage devices, and a control device configured to issue a command concerning data access to the plurality of storage devices,
wherein
the control device comprises an ordering module configured to order local clock adjustment to cause a local clock managed by each of the storage devices to synchronize with local clocks managed by other storage devices, and the storage device comprises:
a storage medium; and
a controller, wherein
the controller
manages a local clock,
adjusts the managed local clock in accordance with the order from the control device to adjust the local clock, and
executes background processing involving access to the storage medium on the basis of the adjusted local clock.

11. The storage system according to claim 10, wherein
the storage device further comprises a memory configured to retain information concerning start timing of the background processing involving access to the storage medium, and wherein
the controller executes the background processing on the basis of the information retained in the memory and the local clock.

12. The storage system according to claim 10, wherein the ordering module orders the adjustment immediately after a power supply of the plurality of storage devices is turned on.

13. The storage system according to claim 11, wherein the ordering module orders the adjustment immediately after a power supply of the plurality of storage devices is turned on.

14. The storage system according to claim 10, wherein the ordering module orders the adjustment in a case where a state in which local clocks of respective storage devices do not synchronize with each other is detected.

15. The storage system according to claim 11, wherein the ordering module orders the adjustment in a case where a state in which local clocks of respective storage devices do not synchronize with each other is detected.

16. The storage system according to claim 10, wherein the ordering module orders the adjustment immediately after a power supply of the plurality of storage devices is turned on and in a case where a state in which local clocks of respective storage devices do not synchronize with each other is detected.

17. The storage system according to claim 11, wherein the ordering module orders the adjustment immediately after a power supply of the plurality of storage devices is turned on and in a case where a state in which local clocks of respective storage devices do not synchronize with each other is detected.

18. In a storage system comprising a plurality of storage devices, and a control device configured to issue a command concerning data access to the plurality of storage devices, a background processing execution method in the storage devices, the method comprising:
adjusting a local clock in each of the plurality of storage devices in accordance with an order for adjustment of the local clock; and
executing background processing on the basis of information concerning start timing of the background processing involving access to a storage medium included in the storage device, and the local clock in a state in which the local clock is synchronized with local clocks managed in other storage devices.

19. The background processing execution method according to claim 18, wherein the local clock is adjusted in accordance with an order from the control device.

20. The background processing execution method according to claim 18, wherein the local clock is adjusted in accordance with an order from another control device.
